(19) United States
(12) Patent Application Publication
(10) Pub. No.: US 2024/0308137 A1
(43) Pub. Date: Sep. 19, 2024

(54) JOINT DESIGN FOR DAPS ADHESIVE FIXTURING

(71) Applicant: Divergent Technologies, Inc., Los Angeles, CA (US)

(72) Inventors: Bahram ISSARI, Laguna Niguel, CA (US); Michael Thomas Kenworthy, Rancho Palos Verdes, CA (US); Loan Chanh Le, Anaheim, CA (US)

(21) Appl. No.: 18/602,844

(22) Filed: Mar. 12, 2024

Related U.S. Application Data
(60) Provisional application No. 63/452,126, filed on Mar. 14, 2023.

(51) Int. Cl. B29C 64/30; B05C 5/02; B29C 64/10; B29C 64/153; B33Y 40/20; B33Y 80/00

(52) U.S. Cl. CPC B29C 64/30; B05C 5/0212; B29C 64/10; B33Y 40/20; B33Y 80/00; B29C 64/153

(57) ABSTRACT

Apparatus and methods for applying adhesives in grooves in additively manufactured (AM) structures are disclosed. An apparatus in accordance with an aspect of the present disclosure comprises an AM structure having a first continuous section with a first groove for receiving a first adhesive and a second discontinuous section with a second groove passing through a portion of the second discontinuous section for receiving a second adhesive, wherein an internal surface of the first continuous section surrounds at least three internal surfaces of the second discontinuous section.

### CROSS-REFERENCE TO RELATED APPLICATIONS

This application claims priority to U.S. Provisional Application No. 63/452,126 titled “Joint Design for DAPS Adhesive Fixturing,” filed on Mar. 14, 2023, which is assigned to the assignee hereof, and incorporated herein by reference in its entirety as if fully set forth herein.

### BACKGROUND

### Field

The present disclosure relates generally to adhesive fixturing techniques, and more specifically to adhesive fixturing techniques for applying adhesives in joints of additively manufactured (AM) structures.

### Background

Three-dimensional (3-D) printing, also referred to as additive manufacturing (AM), has recently presented new opportunities to more efficiently build complex transport structures, such as automobiles, aircraft, boats, motorcycles, busses, trains, and the like. AM techniques are capable of fabricating complex components from a wide variety of materials. Applying AM processes to industries that produce these products has proven to produce a structurally more efficient transport structure. For example, an automobile produced using 3-D printed components can be made stronger, lighter, and consequently, more fuel efficient. Moreover, AM enables manufacturers to 3-D print components that are much more complex and that are equipped with more advanced features and capabilities than components made via traditional machining and casting techniques. The 3-D objects may be formed using layers of material based on a digital model data of the object. A 3-D printer may form the structure defined by the digital model data by printing the structure one layer at a time.

A 3-D printer may disseminate a powder layer (e.g., powdered metal) on an operating surface. The 3-D printer may then consolidate particular areas of the powder layer into a layer of the object, e.g., by using a laser to melt or sinter the powder of the powder layer together. The steps may be repeated to sequentially form each layer. Accordingly, the 3-D printed object may be built layer by layer to form the 3-D object.

3-D printing is non-design specific, which offers geometric and design flexibility that conventional manufacturing processes cannot. Furthermore, 3-D printing technologies can produce parts with very small feature sizes, and geometries that are either significantly difficult or impossible to produce using conventional manufacturing processes.

Very large components which exceed printer size specifications can be segregated at the design phase, printed in parallel and combined. Further, 3-D printed components may be used to produce sub-components for various devices or apparatus. The 3-D printed sub-components may need to be attached or connected to other sub-components, including other 3-D printed sub-components, extruded sub-components, COTS parts, or still other sub-components. In other cases, structures or structures as described herein may need to be attached to other structures or to joints, extrusions, and other parts. For these and other exemplary cases, adhesives may be used to combine two or more 3-D printed parts.

Despite these recent advances, a number of obstacles remain with respect to the practical implementation of AM techniques in transport structures and other mechanized assemblies. For instance, current fixturing methods for bonding of structures entails a tongue-and-groove type joint which is continuous in nature. A rapid fixturing adhesive may be dispensed within the groove such that a tongue segment of the structure may be inserted into the groove. The rapid fixturing adhesive is then subjected to heat to affect the curing of the adhesive and bonding of the assembly. Thus, the continuous segment is interrupted by one or more several discreet sections that are filled with the rapid fixturing adhesive. Such rapid fixturing adhesives may have sufficient properties to act in a structural manner. The purpose of applying the rapid fixturing adhesive is to fixture the structures together during assembly in a rapid manner.

Actinic radiation may then be used for triggering curing of these adhesives, which requires use of open windows on the outside surface to allow for penetration of such radiation. In these instances, the continuous segment may be partitioned to several segments that are closed and have no windows. However, these external chambers are bulky and add steric issues to the assembly. The adhesive is dispensed in a continuous manner along an adhesive path via injection within the groove segment of the joint. During this process, the injection mechanism will arrive at ultraviolet (UV) feature, which needs to be protected from the dispensed adhesive. At this junction, dispensing is paused to bypass the UV feature and then the restarted once the UV feature is cleared while the dispenser moves along the adhesive path. However, the pausing and restarting of the dispensing pauses along the adhesive path adds time to the overall assembly process. In addition, pausing and restarting the dispensing also increases the risk of the contaminating other segments of the structure with the adhesive. Thus, it is advantageous to minimize or eliminate the pauses altogether.

### SUMMARY

Several aspects of apparatus for systems and methods for joint designs for adhesive fixturing will be described more fully hereinafter with reference to three-dimensional printing techniques.

An apparatus in accordance with an aspect of the present disclosure comprises an additively manufactured structure having a first continuous section with a first groove for receiving a first adhesive and a second discontinuous section with a second groove passing through a portion of the second discontinuous section for receiving a second adhesive, where an internal surface of the first continuous section surrounds at least three internal surfaces of the second discontinuous section.

A method in accordance with an aspect of the present disclosure comprises printing, by adhesive manufacturing, a structure having a first continuous section with a first groove for receiving a first adhesive and a second discontinuous section with a second groove passing through a portion of the second discontinuous section for receiving a second adhesive, where an outer surface of the first continuous section surrounds at least three interior surfaces of the second discontinuous section.

It will be understood that other aspects of joining structures (or structures) and subcomponents will become readily apparent to those skilled in the art from the following detailed description, wherein it is shown and described only several embodiments by way of illustration. As will be realized by those skilled in the art, the apparatus for adhesive fixturing is capable of other and different embodiments, and its several details are capable of modification in various other respects, all without departing from the invention. Accordingly, the drawings and detailed description are to be regarded as illustrative in nature and not as restrictive.

### BRIEF DESCRIPTION OF THE DRAWINGS

Various aspects of apparatus and methods for printing joints with additively manufactured structures will now be presented in the detailed description by way of example, and not by way of limitation, in the accompanying drawings, wherein:

FIGS. 1A-1D illustrate respective side views of an exemplary PBF system during different stages of operation in accordance with an aspect of the present disclosure.

FIG. 1E illustrates a functional block diagram of a three-dimensional (3-D) printer system in accordance with an aspect of the present disclosure.

FIGS. 2 is a diagram illustrating a top view of an additively manufactured (AM) female structure in accordance with an aspect of the present disclosure.

FIG. 3A-3C are diagrams illustrating a first structure in accordance with an aspect of the present disclosure.

FIG. 4 is a diagram illustrating a perspective view of a second structure in accordance with an aspect of the present disclosure.

FIG. 5 is a diagram illustrating a connection at a retention feature between structures in accordance with an aspect of the present disclosure.

FIG. 6 is a diagram illustrating a top view of an example of an AM female structure with a UV feature in accordance with an aspect of the present disclosure.

FIG. 7 is a diagram illustrating a top view illustrating an AM female with a UV feature structure in accordance with an aspect of the present disclosure.

FIG. 8 is flowchart illustrating an example method in accordance with the systems and methods described herein.

FIG. 9 is flowchart illustrating an example method in accordance with the systems and methods described herein.

### DETAILED DESCRIPTION

The detailed description set forth below in connection with the drawings is intended to provide a description of exemplary embodiments of joining additively manufactured structures (or structures) and subcomponents, and it is not intended to represent the only embodiments in which the disclosure may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the disclosure to those skilled in the art. However, the disclosure may be practiced without these specific details. In some instances, well-known structures and components may be shown in block diagram form, or omitted entirely, in order to avoid obscuring the various concepts presented throughout this disclosure.

The use of additive manufacturing and using adhesives in the context of joining two or more parts provides significant flexibility and cost saving benefits that enable manufacturers of mechanical structures and mechanized assemblies to manufacture parts with complex geometries at a lower cost to the consumer. The joining techniques described in the foregoing relate to a process for connecting additively manufactured parts and/or commercial of the shelf (COTS) components. Additively manufactured (AM) parts are printed three-dimensional (3-D) parts that are printed by adding layer upon layer of a material based on a preprogramed design. The parts described in the foregoing may be parts used to assemble a motor vehicle such as an automobile. However, those skilled in the art will appreciate that the manufactured parts may be used to assemble other complex mechanical products such as vehicles, trucks, trains, motorcycles, boats, aircraft, and the like without departing from the scope of the invention.

By utilizing additive manufacturing techniques to co-print parts it becomes simpler to join different parts and/or components in the manufacturing process by applying adhesives. Additive manufacturing provides the ability to create complex structures within a part. For example, a part such as a structure may be printed with a port that enables the ability to secure two parts by injecting an adhesive rather than welding two parts together, as is traditionally done in manufacturing complex products.

In one aspect of the disclosure, a joining technique for additively manufactured structure is disclosed. Structures as described herein may further include structures for joining joints, tubes, panels, and other components for use in a transport structure or other mechanical assembly. For example, structures may include joints that may act as an intersecting points for two or more joints, panels, connecting tubes, or other structures.

A structure (or node) is an example of an AM part. A structure may be any 3-D printed part that includes a socket or other mechanism (e.g., a feature to accept these parts) for accepting a component such as a tube and/or a panel. The structure may have internal features configured to accept a particular type of component. Alternatively or conjunctively, the structure may be shaped to accept a particular type of component. A structure, in some embodiments of this disclosure may have internal features for positioning a component in the structure's socket. To this end, the structures may be configured with apertures or insets configured to receive such other structures such that the structures are fit securely at the structure. Structures may join connecting tubes to form a space frame vehicle chassis. Structures may also be used to join internal or external panels and other structures. In many cases, individual structures may need to be joined together to accomplish their intended objectives in enabling construction of the above described structures. However, as a person having ordinary skill in the art will appreciate, a structure may utilize any feature comprising a variety of geometries to accept any variety of components without departing from the scope of the disclosure. For example, certain structures may include simple insets, grooves or indentations for accepting other structures, which may be further bound via adhesives, fasteners or other mechanisms.

### Additive Manufacturing

Additive Manufacturing (AM) involves the use of a stored geometrical model for accumulating layered materials on a build plate to produce a three-dimensional (3-D) build piece having features defined by the model. AM techniques are capable of printing complex components using a wide variety of materials. A 3-D object may be fabricated based on a computer aided design (CAD) model. The CAD model can be used to generate a set of instructions or commands that are compatible with a particular 3-D printer. The AM process can create a solid three-dimensional object using the CAD model and print instructions. In the AM process, different materials or combinations of material, such as engineered plastics, thermoplastic elastomers, metals, ceramics, and/or alloys or combinations of the above, etc., may be used to create a uniquely shaped 3-dimensional object.

The use of AM in the context of joining two or more components may provide significant flexibility and cost saving benefits. These, and other benefits may enable manufacturers of mechanical structures to produce components at a lower cost and/or in a more efficient manner. The joining techniques described in the present disclosure relate to a process for connecting AM components and/or commercial off the shelf (COTS) components. AM components are 3-D components that are printed by, for example, adding layer upon layer of one or more materials based on a preprogramed design. The components described herein may be components used to assemble a variety of devices, such as engine components, structural components, etc. Further, such AM or COTS components may be used in assemblies, such as vehicles, trucks, trains, motorcycles, boats, aircraft, and the like, or other mechanized assemblies, without departing from the scope of the present disclosure.

### Components and Terminology in AM

In an aspect of the present disclosure, a component is an example of an AM component. A component may be any 3-D printed component that includes features, such as an interface, for mating with another component. The component may have internal or external features configured to accept a particular type of component. Alternatively or additionally, the component may be shaped to accept a particular type of component. A component may utilize any internal design or shape and accept any variety of components without departing from the scope of the disclosure.

A number of different AM technologies may be well-suited for construction of components in a transport structure or other mechanized assembly. Such 3-D printing techniques may include, for example, directed energy deposition (DED), selective laser melting (SLM), selective laser sintering (SLS), direct metal laser sintering (DMLS), electron beam melting (EBM), powder bed fusion (PBF), and/or other AM processes involving melting or fusion of metallic powders.

As in many 3-D printing techniques, these processes (e.g., PBF systems) can create build pieces layer-by-layer. Each layer or “slice” is formed by depositing a layer of powder and exposing portions of the powder to an energy beam. The energy beam is applied to melt areas of the powder layer that coincide with the cross-section of the build piece in the layer. The melted powder cools and fuses to form a slice of the build piece. The process can be repeated to form the next slice of the build piece, and so on. Each layer is deposited on top of the previous layer. The resulting structure is a build piece assembled slice-by-slice from the ground up. SLS and various other PBF techniques may be well suited to construction of gear cases and other transport structure components. However, it will be appreciated that other AM techniques, such as fused deposition modeling (FDM) and the like, are also possible for use in such applications.

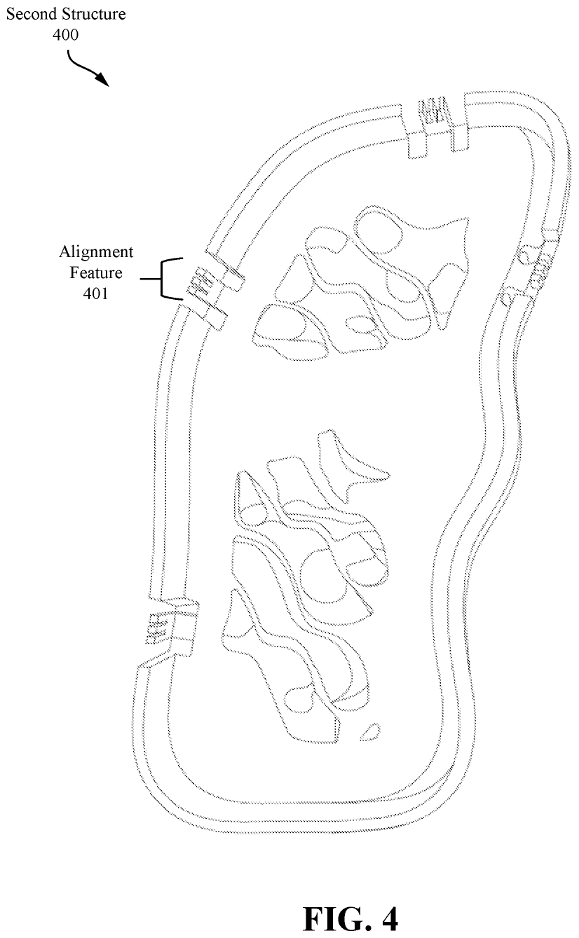

A tongue-and-groove (TNG) structure may be used to connect two or more components at an interface. For example, a tongue portion of one component may extend all the way around a peripheral region as a single protrusion disposed around the peripheral region. The tongue portion of a component (e.g., alignment feature 401 shown in FIG. 4) may protrude outward along the peripheral region relative to that component, and the lateral extension of the tongue portion can be considered in this view as “coming out” of that component.

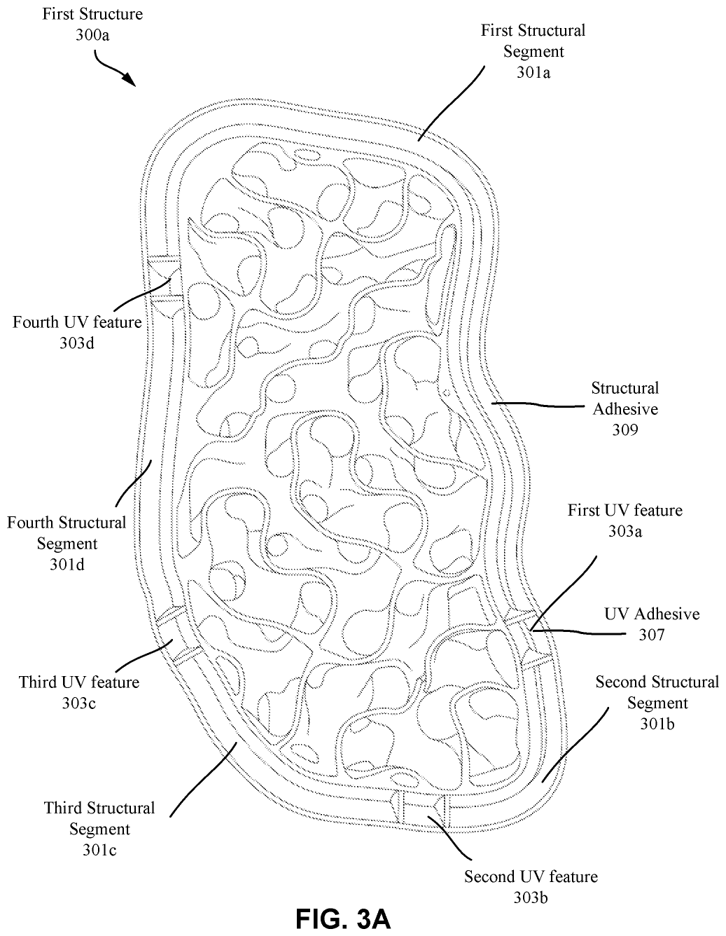

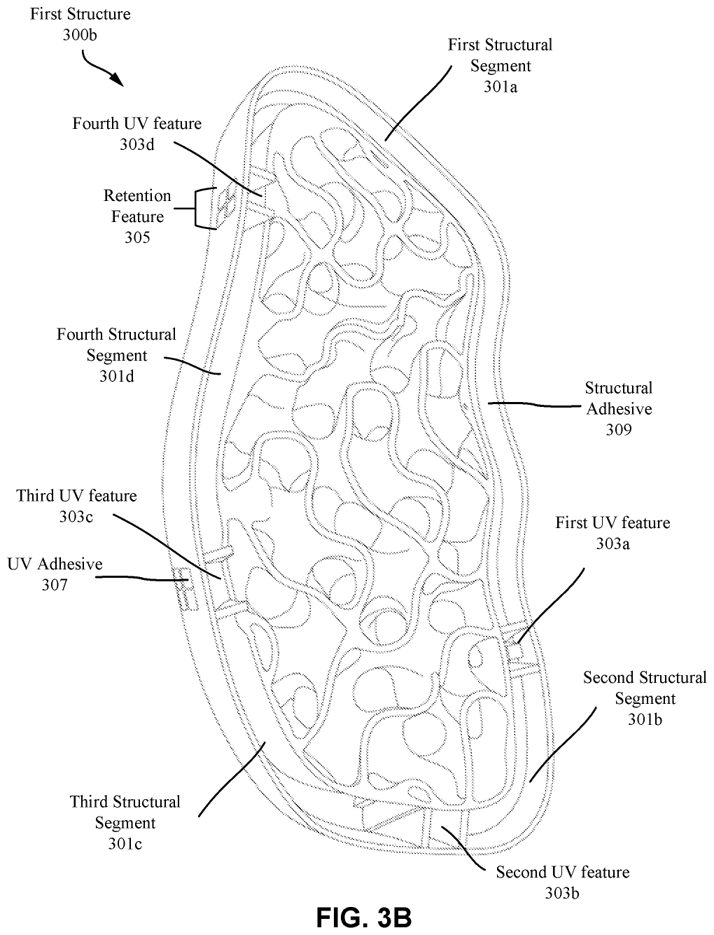

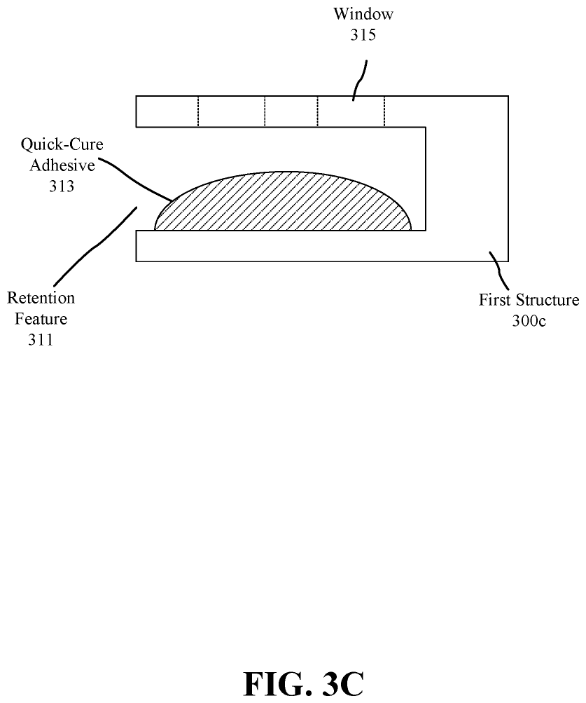

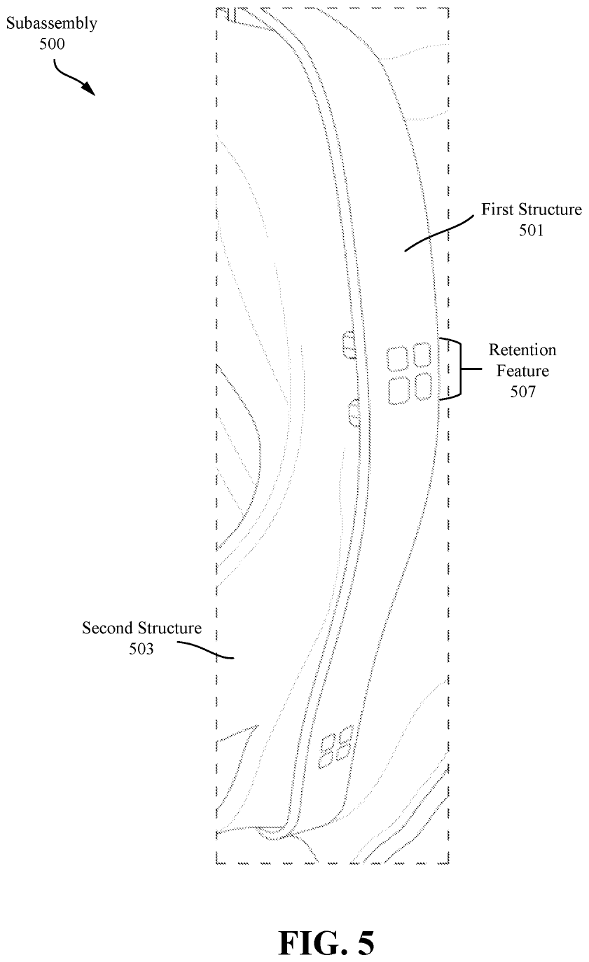

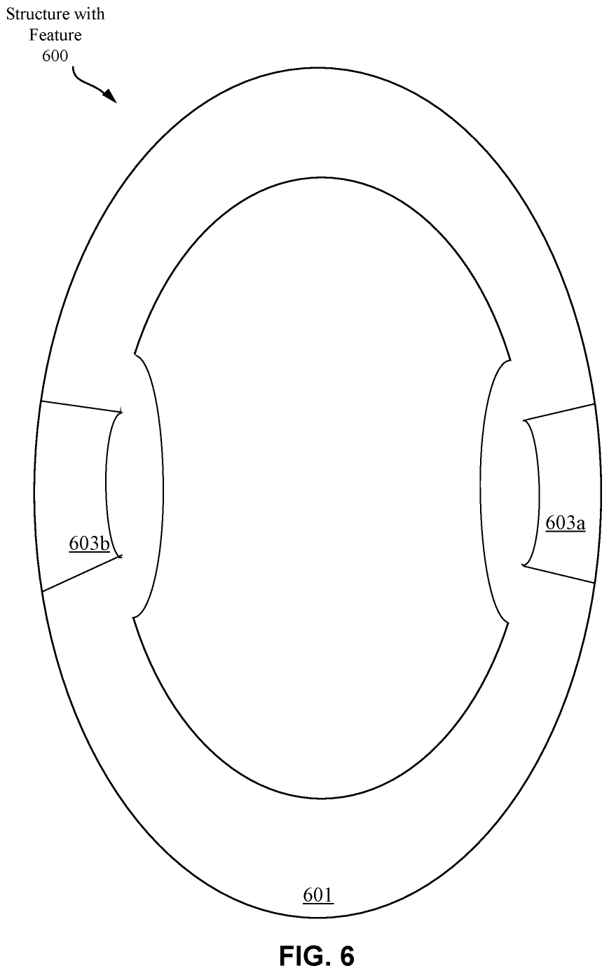

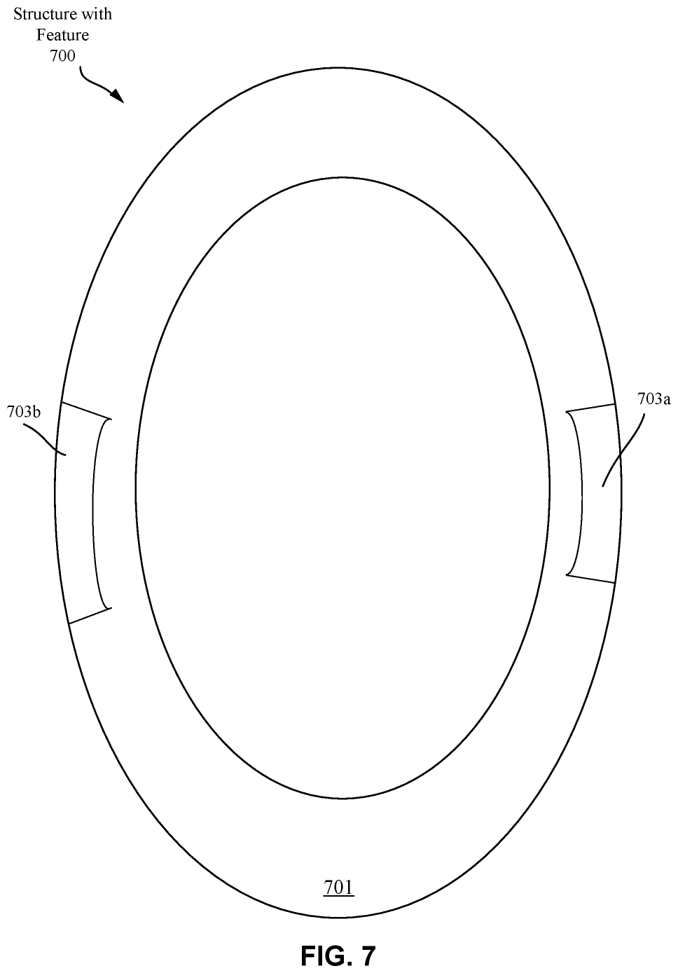

A groove portion of an interface (e.g., various structural segments 301a, 301b, 301c, 301d shown in FIGS. 3A-3C, structural section 601 shown in FIG. 6, continuous structural section 701 shown in FIG. 7) is a portion of a second component and may be disposed along a peripheral region of the second component. The groove portion may, but need not, comprise the material of the second component. The groove portion may extend all the way around the peripheral region and may be a single channel in the second component. The groove portion may also be inset inward along the peripheral region relative to the second component and runs laterally around the second component. The tongue and groove may be arranged on the first and second components such that when the two components are placed into contact (e.g., subassembly 500 shown in FIG. 5), the tongue may align with the groove and may fit into the groove around the peripheral regions at the interface between the two components.

While the disclosure relates primarily to using a tongue-and-groove structure to join two or more components, the techniques described in this disclosure are not only applicable to tongue-and-groove structures. In fact, any suitable technique for joining multiple structures may be used without departing from the scope of the disclosure.

AM may include the manufacture of one or more nodes. A node is a structural member that may include one or more interfaces used to connect to other nodes or spanning components such as tubes, extrusions, panels, and the like. Using AM, a node may be constructed to include additional features and functions, including interface functions, depending on the objectives. As described herein, the term node and structure may be used interchangeably.

As described above, nodes and other components may be connected together. For example, one or more nodes and/or other components may be connected together to form larger components. Accordingly, individual AM structures often need to be connected together, or individual AM structures often need to be connected to machined or COTS parts, to provide combined structures, e.g., to realize the above modular network or to form a complex interior assembly in a vehicle. Examples include structure-to-structure connections, structure-to-panel connections, structure-to-tube connections, and structure-extrusion connections, among others. To connect an AM joint member with a vehicle body panel, for example, mechanical connectors (e.g., screws, clamps, etc.) may be used. Alternatively or additionally, an adhesive may be used to form a strong bond. For connecting these parts, a strict tolerance is often required, meaning that the parts must be positioned to fit precisely in an established orientation. For example, the two parts to be adhered may need to be positioned to avoid direct contact with each other in order to mitigate possible galvanic corrosion problems. In general, an adhesive connection between the AM joint member and panel should result in an accurate fit. Thus the AM joint member should not be misaligned with or offset from the body panel, for example, and the parts should remain properly oriented when a permanent bond is established.

The present disclosure is directed to a redesign of structure joints in proximity to chambers along the groove of a structure by removing the chambers in the way of an adhesive dispensing path. In an aspect of the present disclosure, an AM manufactured structure may have a first continuous section with a first groove for receiving a first adhesive and a second discontinuous section with a second groove passing through a portion of the second discontinuous section for receiving a second adhesive. In an aspect of the present disclosure, an internal surface of the first continuous section may surround at least three internal surfaces of the second discontinuous section.

In some aspects of the present disclosure, the AM structure may have a first continuous section (e.g., structural section 601 shown in FIG. 6) with a portion of an outer surface having a convex shape. In other aspects of the present disclosure, the AM structure may have a second discontinuous section (e.g., UV feature 603a, 603b shown in FIG. 6 or UV feature 703a, 3 with an outer surface with a window. In other aspects of the present disclosure, the first adhesive may be injected, via a robotic applicator, in a continuous manner within the first groove segment of the joint and the second adhesive may be injected, via the robotic applicator, in a continuous manner within the second groove segment of the joint. The disclosure covers the use of structural adhesives and UV curable adhesives to bond the parts, including conventional adhesives and also including sealants or other materials that may have adhesive properties.

### Additive Manufacturing Environment

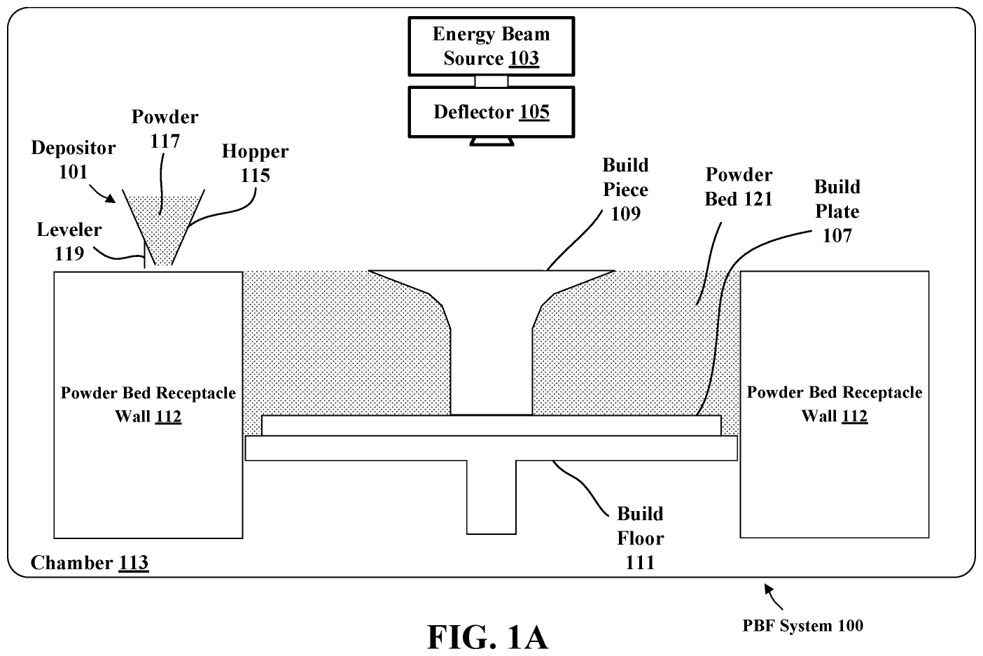

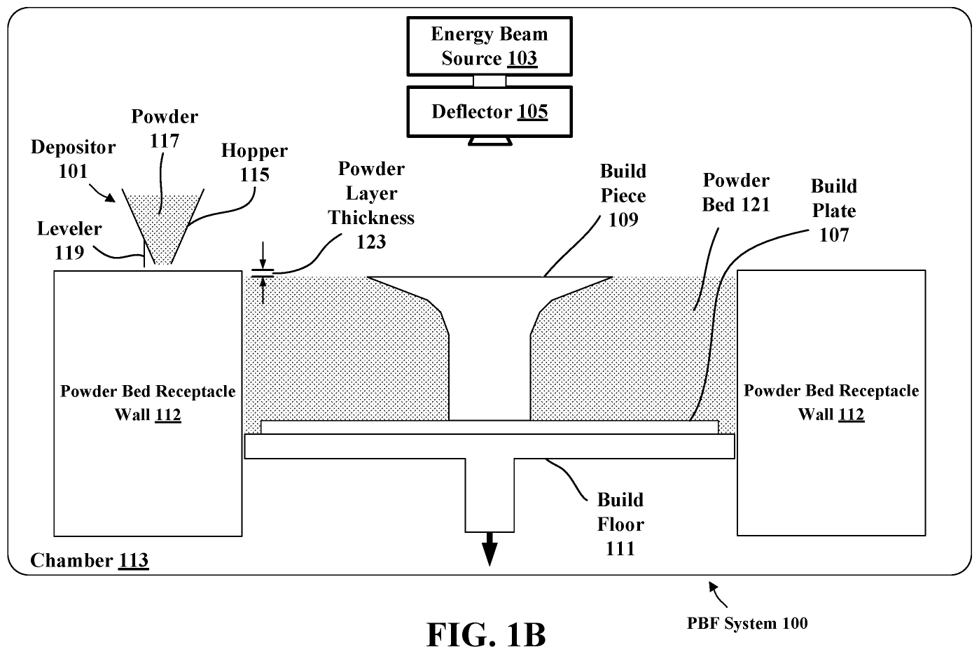

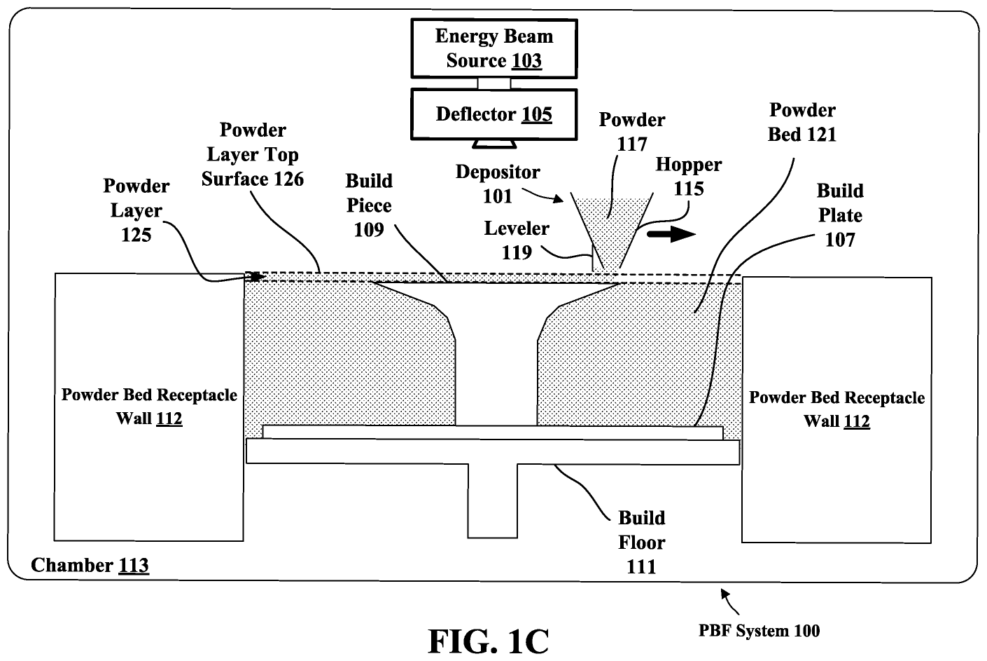

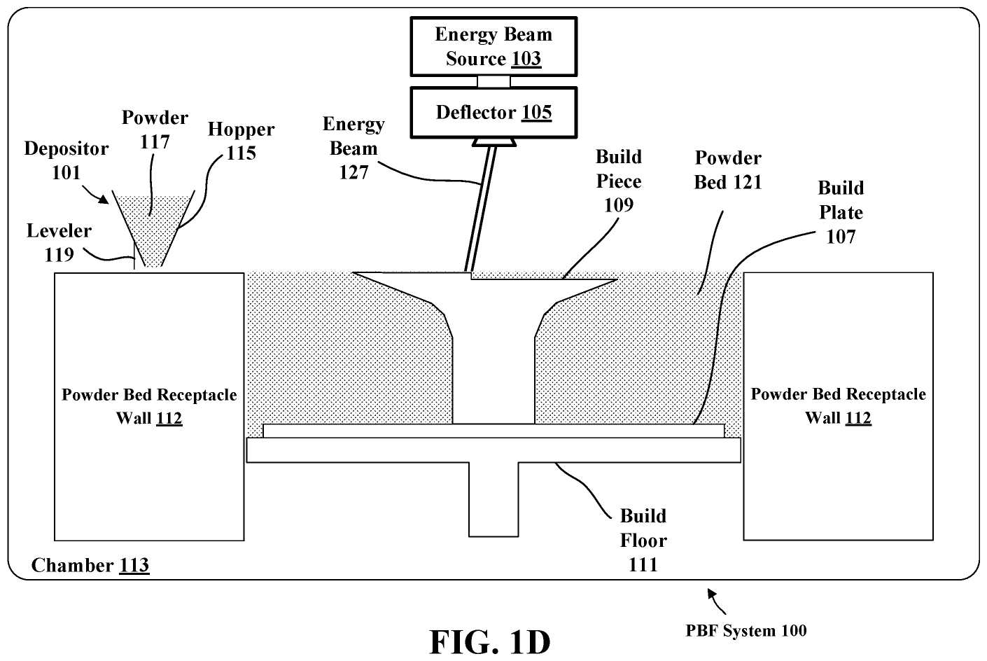

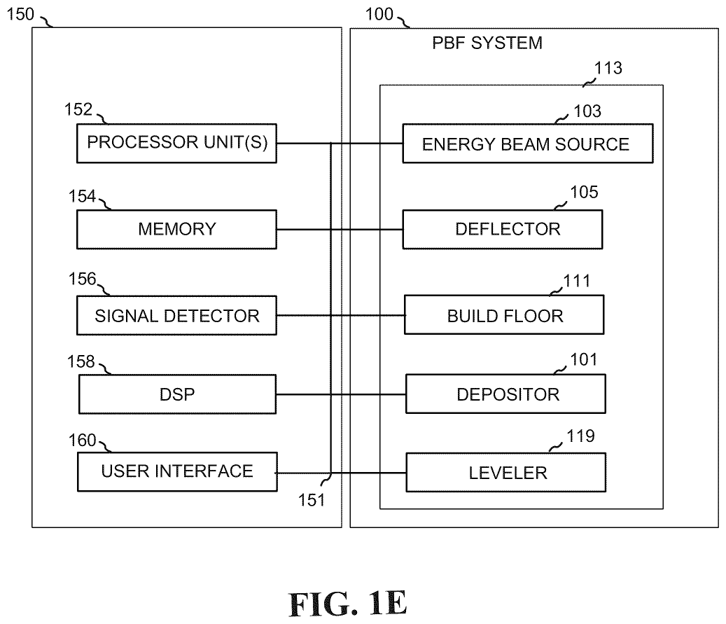

FIGS. 1A-1D illustrate respective side views of a 3-D printer system in an aspect of the present disclosure.

In an aspect of the present disclosure, a 3-D printer system may be a powder-bed fusion (PBF) system 100. FIGS. 1A-D show PBF system 100 during different stages of operation. The particular embodiment illustrated in FIGS. 1A-1D is one of many suitable examples of a PBF system employing principles of this disclosure. It should also be noted that elements of FIGS. 1A-1D and the other figures in this disclosure are not necessarily drawn to scale, but may be drawn larger or smaller for the purpose of better illustration of concepts described herein. PBF system 100 can include a depositor 101 that can deposit each layer of metal powder, an energy beam source 103 that can generate an energy beam, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 can also include a build floor 111 positioned within a powder bed receptacle. The walls of the powder bed receptacle 112 generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 200 individual layers, to form the current state of build piece 109, e.g., formed of 200 individual slices. The multiple individual layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of build piece 109 and powder bed 121 are lower than the top of powder bed receptacle wall 112 by an amount equal to the powder layer thickness 123. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that leaves powder layer top surface 126 configured to receive fusing energy from energy beam source 103. Powder layer 125 has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving the 200 previously-deposited individual layers discussed above with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109. In various exemplary embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 can include an optical system that uses reflection and/or refraction to manipulate the laser beam to scan selected areas to be fused.

In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

FIG. 1E illustrates a functional block diagram of a 3-D printer system in accordance with an aspect of the present disclosure.

In an aspect of the present disclosure, control devices and/or elements, including computer software, may be coupled to PBF system 100 to control one or more components within PBF system 100. Such a device may be a computer 150, which may include one or more components that may assist in the control of PBF system 100. Computer 150 may communicate with a PBF system 100, and/or other AM systems, via one or more interfaces 151. The computer 150 and/or interface 151 are examples of devices that may be configured to implement the various methods described herein, that may assist in controlling PBF system 100 and/or other AM systems.

In an aspect of the present disclosure, computer 150 may comprise at least one processor unit 152, memory 154, signal detector 156, a digital signal processor (DSP) 158, and one or more user interfaces 160. Computer 150 may include additional components without departing from the scope of the present disclosure.

The computer 150 may include at least one processor unit 152, which may assist in the control and/or operation of PBF system 100. The processor unit 152 may also be referred to as a central processing unit (CPU). Memory 154, which may include both read-only memory (ROM) and random access memory (RAM), may provide instructions and/or data to the processor 304. A portion of the memory 154 may also include non-volatile random access memory (NVRAM). The processor 152 typically performs logical and arithmetic operations based on program instructions stored within the memory 154. The instructions in the memory 154 may be executable (by the processor unit 152, for example) to implement the methods described herein.

The processor unit 152 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor unit 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

The computer 150 may also include a signal detector 156 that may be used to detect and quantify any level of signals received by the computer 150 for use by the processing unit 152 and/or other components of the computer 150. The signal detector 156 may detect such signals as energy beam source 103 power, deflector 105 position, build floor 111 height, amount of powder 117 remaining in depositor 101, leveler 119 position, and other signals. Signal detector 156, in addition to or instead of processor unit 152 may also control other components as described with respect to the present disclosure. The computer 150 may also include a DSP 158 for use in processing signals received by the computer 150. The DSP 158 may be configured to generate instructions and/or packets of instructions for transmission to PBF system 100.

The computer 150 may further comprise a user interface 160 in some aspects. The user interface 160 may comprise a keypad, a pointing device, and/or a display. The user interface 160 may include any element or component that conveys information to a user of the computer 150 and/or receives input from the user.

The various components of the computer 150 may be coupled together by a bus system 151. The bus system 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, one or more of the components may be combined or commonly implemented. For example, the processor unit 152 may be used to implement not only the functionality described above with respect to the processor unit 152, but also to implement the functionality described above with respect to the signal detector 156, the DSP 158, and/or the user interface 160. Further, each of the components illustrated in FIG. 1E may be implemented using a plurality of separate elements.

By way of example, an element, or any portion of an element, or any combination of elements may be implemented using one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors may execute software as that term is described above.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

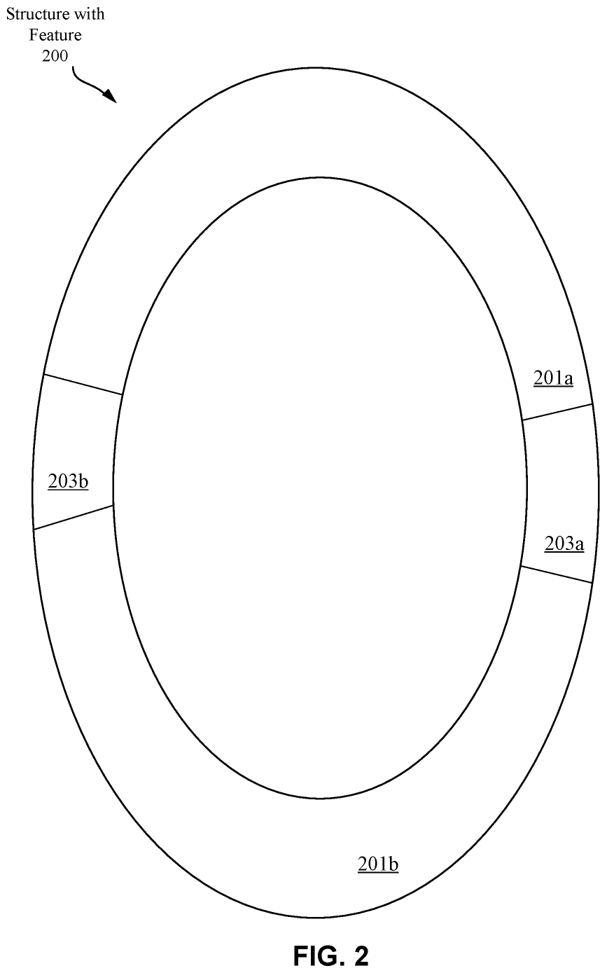

Current methods include a tongue-and-groove type joint which is continuous in nature. Specifically, a first AM structure (e.g., the structural sections 201a, 201b, 301a, 301b, 301c, 301d shown in FIGS. 2, 3A-3B) may have a groove and a second AM structure (e.g., the second structure shown in FIG. 4) may have a tongue extending into the groove to form a tongue-and-groove connection between the first and second structure (e.g., subassembly 500 shown in FIG. 5). A structural adhesive (e.g., structural adhesive 309 shown in FIGS. 3A-3B) may be dispensed within the groove of the first structure and a quick-cure UV adhesive (e.g., UV adhesive 307 shown in FIG. 3B) may be dispensed within the retention features of the first structure. The tongue segment of the second structure is then inserted into the groove. The first and second adhesive are then heated up such that the first structure is bonded to the second structure by the adhesive and reinforced by the tongue-and-groove connection.

FIG. 2 illustrates a top view of an example of an AM female structure with a UV feature 200 in accordance with an aspect of the present disclosure.

Specifically, FIG. 2 shows a AM female structure with the UV feature 200 with a tongue and groove joint close to UV feature 203a, 203b (or segment). The AM female structure with the UV feature 200 may be employed in various operations associated with fixtureless assembly of a vehicle, such as robotic assembly of a structure-based vehicle. The AM female structure with the UV feature 200 may include one or more elements associated with at least a portion of the assembly of a vehicle without any fixtures. For example, one or more elements of the AM female structure with the UV feature 200 may be configured for one or more operations in which a first structure is joined with one or more other structures without the use of any fixtures during robotic assembly of a structure-based vehicle.

As shown in FIG. 2, a robotic applicator (or adhesive dispensing robot) may include a dispenser for dispensing a rapid fixturing adhesive by injection in a discontinuous adhesive path within the groove segment of the joint due to at least one UV feature 203a, 203b displaced between the first structural section 201a, second structural section 201b of the structure. For example, the rapid fixturing adhesives may be applied, e.g., deposited in a groove of one of the first structural sections (e.g., structural sections 301a-d from FIGS. 3A-3C, structural section 601 from FIG. 6, and continuous structural section 701 from FIG. 7) of the first structures, to one or more joints or other connections between a first structure and a second structure (e.g., second structure 400 from FIG. 4). The rapid fixturing adhesives may have sufficient properties to act in a structural manner. In some examples, actinic radiation may be used for triggering cure of such adhesives, which may require use of open windows on the exterior surface to allow for penetration of such radiation. In some examples, the rapid fixturing adhesives may be applied separately from fixtureless assembly system.

Specifically, during this process, the robotic applicator may arrive at the UV feature 203a or 203b, which needs to be protected from the dispensed structural adhesive to avoid contamination within the chambers of the UV features 203a, 203b, along an adhesive path. At this juncture, dispensing of the structural adhesive along the adhesive path is paused so as to bypass dispensing the structural adhesive in the UV feature 203a, 203b before restarting the dispensing of the structural adhesive process along the adhesive path once a UV feature is cleared.

After the structural adhesive is placed in the first structural section 201a and the second structural section 201b of the AM female structure with the UV feature 200, the robotic applicator may inject a UV (or quick-cure) adhesive into windows (e.g., retention features 305 shown in FIG. 3B) of the UV features 203a, 203b. After the UV adhesive is dispensed into the windows, the structure may be exposed to EM radiation (e.g., UV light) to cure the UV adhesive contained within the retention features. An AM male structure (e.g., the second structure 400 from FIG. 4) may include an alignment feature (e.g., alignment feature 401), which may also be referred to as a tongue, which a material handling robot may place into the UV adhesive within the retention feature of the female structure with the UV feature 200. The tongue may include a plurality of segments spaced apart from each other (e.g., a comb shape shown in FIG. 4), a plurality of openings (e.g., a waffle or grid shape) or may be solid tongue which contacts the UV adhesive when the alignment feature (e.g., tongue) is inserted into the retention feature.

Accordingly, the pausing and starting of the adhesive dispenser along an adhesive path adds time to the overall assembly process and may also cause issues in connection of the structures due to contamination. For example, the frequent starting and stopping of the dispenser may cause the adhesive to “string.” “Stringing” occurs when a portion of the adhesive material is left behind on an nozzle of the dispenser and pulled into a string, either automatically or manually when a dispenser is pulled away from the surface. The string of adhesive that is left behind may also be referred to as “angel hair.” In automotive applications, precision adhesive application on visible parts is an important part of ensuring a clean appearance for an automobile.

More importantly, the “stringing” of adhesives may cause contamination to other parts. For instance, starting and stopping the robotic dispenser along the adhesion path may cause contamination of the structural adhesive in the chambers of the UV features 203a, 203b and/or contamination of the UV adhesives in the structural sections 201a, 201b. For example, when an adhesive dispensing robot is configured to dispense both structural adhesive in a structural section and UV adhesive in the chambers of the UV features, typically, the robotic assembler will dispense structural adhesive in the structural sections first and then UV adhesive in the UV chambers to mitigate contamination and adhesion issues.

If UV adhesive is placed before the structural adhesive then, as the robotic assembler is placing the structure adhesive, there may be contamination in the UV chamber due to “stringing” from the structural adhesive. In this case, the structural adhesive may be sitting on top of the UV adhesive. As such, when the tongue portion of a male structure is pushed in (e.g., the two structures are joined together), the tongue portion may also pick up the structural adhesive as the tongue is going into the UV adhesive. As a result, the structural adhesive coats (e.g., contaminates) the tongue part such that the UV adhesive may not bond well since the UV adhesive needs to bond to the tongue part that it is going in. Accordingly, the structural adhesive is placed first because, even if it is causing contamination, it is contaminating part of the chamber. Thus, it is better to apply adhesives in this order because the tongue that is going in the groove will not be contaminated since it provides better bonding characteristics.

Nevertheless, even applying the structural adhesive before the UV adhesions may cause issues by contaminating the UV chambers with structural adhesives. More importantly, the dispensing's starting and stopping adds time to the overall assembly process. Thus, it is advantageous to minimize or eliminate the pauses altogether.

FIG. 3A-3C are diagrams illustrating a first structure 300a, 300b, 300c in accordance with an aspect of the present disclosure.

Specifically, FIG. 3A shows a top view of a first structure 300a (e.g., AM female structure with the UV feature 200 shown in FIG. 2) with various UV features 303a, 303b, 303c, 303d with a tongue-and-groove type joint close to the respective UV features and grooves. It should be noted that the AM female structure with the UV feature 200 shown in FIG. 2 is a simplified version of the first structure 300a.

In some examples, when a robotic applicator injects a structural adhesive 309 within the groove of the first structural segment 301a, second structural segment 301b, third structural segment 301c, and fourth structural segment 301d of the first structure 300a, the robotic applicator must pause application of the first adhesive along its adhesion path at locations of the first UV feature 303a, second UV feature 303b, third UV feature 303c, and fourth UV feature 303d and then restart application of the first adhesion after each UV feature is cleared along the adhesive path.

FIG. 3B shows a perspective view of the first structure 300b (e.g., AM female structure with the UV feature 200 shown in FIG. 2) with various UV features 303a, 303b, 303c, 303d with a tongue-and-groove joint close to the respective UV features and grooves. Specifically, FIG. 3B shows retention features 305 on each of the UV features where a quick-cure UV adhesive 307 may be applied.

The retention features 305 may serve multiple functions, e.g., a visual assurance that a first structure and second structure are coupled together, alignment of the first structure and the second structure, etc. Further, retention features 305 may serve as an insertion point for an adhesive to bond first structure and second structure together.

A structural adhesive 309 applied in the first structural segment 301a, second structural segment 301b, third structural segment 301c, and fourth structural segment 301d coupled the first structure (e.g., the first structure 300a, 300b shown in FIGS. 3A-3B) and the second structure (e.g., the second structure 400 shown in FIG. 4) together. Next, a second adhesive, such as a quick-cure UV adhesive 307, may be placed through the retention features 305 (e.g., window) of the first structure 300b.

FIG. 3C illustrates a cross-sectional side view of a component in accordance with an aspect of the present disclosure.

During assembly of various components, first structure 300c, having retention feature 311, may have quick-cure adhesive 313 placed in retention feature 311 in preparation for receiving a mating component. Quick-cure adhesive 313 may be placed into retention feature 311 via window 315.

Because quick-cure adhesive 313 is fluidic, and retention feature 311 has multiple openings, e.g., an opening for receiving another structure, window(s) 315, etc. the viscosity of the quick-cure adhesive 313 may be limited to those adhesives that will remain in retention feature 311 until a mating component can be brought into proximity with first structure 300c. If an adhesive with too low of a viscosity is chosen, such an adhesive will flow out of retention feature 311 before a mating component (e.g., alignment feature 401 from the second structure 400 shown in FIG. 4) can be brought into contact with the quick-cure adhesive 313, which may result in inadequate adherence of the mating component with first structure 300c.

In some embodiments, a robot may be used for multiple roles. For example, a robot may perform the role of an assembly robot and the role of a UV robot. A assembly/UV robot may offer functionality similar to each of the assembly robots when the distal end of the robotic arm of the assembly/UV robot includes an end effector (e.g., connected by means of a tool flange). However, the assembly/UV robot may offer functionality similar to UV robot when the distal end of the robotic arm of the assembly/UV robot includes a tool configured to apply UV adhesive and to emit UV light to cure the UV adhesive.

FIG. 4 illustrates a perspective view of a second structure 400 in accordance with an aspect of the present disclosure.

Specifically, FIG. 4 shows a perspective view of a second structure 400 (e.g., AM male structure) with at least one alignment feature 401 that corresponds to each of the retention features from the first structure 300a, 300b shown in FIGS. 3A-3B. The alignment feature 401, which may be a tongue or other feature of the AM male structure, may include a waffle shape, a fork shape, a comb shape, a loop shape, a snake shape, or other shapes without departing from the scope of the present disclosure. The shape of the alignment feature 401 may be selected to increase the strength of the adhesive bond between the first structure and the second structure and/or to improve printability of the second structure 400 (e.g., in additive manufacturing). For example, when the alignment feature 401 is adhered to retention feature 305 from FIG. 3B or retention feature 311 from FIG. 3C, the alignment feature 401 with a comb shape may require a maximum pull force of approximately 100 N more than an alignment feature with the other aforementioned tongue types (e.g., due to additional surface area contacting the quick-cure adhesive between the plurality of segments of the comb shape). Therefore, a comb-shape may be selected for alignment feature 401 to increase the strength of the bond between first structure and second structure. Alternatively, an alignment feature 401 with waffle shape may be selected, with slightly less strength, because the waffle shape may be easier to print than other tongue shapes. Other tongue types may be selected to balance adhesive strength and printability, or other factors, without departing from the scope of the present disclosure.

### Joint Assembly

FIG. 5 illustrates a connection at a retention feature between structures in accordance with an aspect of the present disclosure.

As other structures (including subassemblies, substructures of structures, etc.) are connected to the first structure, a robot may retain the engagement with the first structure through an end effector. The aggregate of the first structure and one or more structures connected thereto may be referred to as a structure itself, but may also be referred to as an assembly or a subassembly. A keystone robot may retain an engagement with an assembly once the keystone robot has engaged the first structure.

As shown in FIG. 5, a subassembly 500 may include multiple structures, e.g., first structure 501 (the first structure 300a, 300b, 300c shown in FIGS. 3A-C) and second structure 503 (the second structure 400 shown in FIG. 4). Where first structure 501 and second structure 503 join, e.g., at interface, first structure 501 may have a retention feature 507 (the retention feature 305 shown in FIG. 3B and retention feature 311 shown in FIG. 3C) while second structure 503 may have an alignment feature (not shown) that is coupled to retention feature 507.

As described above in FIG. 3B, the retention feature 507 may serve multiple functions, e.g., a visual assurance that first structure 501 and second structure 503 are coupled together, alignment of the first structure 501 and second structure 503, etc. Further, retention feature 507 may serve as an insertion point for an adhesive to bond first structure 501 and second structure 503 together.

In some cases, when first structure 501 and second structure 503 are coupled together, an adhesive, such as a quick-cure, may be placed in alignment feature, while a second adhesive, such as a structural adhesive, may be placed elsewhere between first structure 501 and second structure 503. The quick-cure adhesive may provide a quick connection for the subassembly 500 during other assembly operations, such that subassembly can be handled and moved as a single piece for other assembly operations.

Moreover, FIG. 5 illustrates an example of a subassembly 500 including a first structure 501 joined to a second structure 503 using the retention feature 507 and alignment feature.

First structure 501 of subassembly 500 may have an adhesive dispensing robot dispense a quick-cure adhesive into retention feature 507. After the adhesive is dispensed into retention feature 507, the first structure 501 may also be exposed to EM radiation, e.g., ultraviolet (UV) light via the retention feature 507, to cure the quick-cure adhesive contained within the retention feature 507. Second structure 503 of subassembly 500 may include an alignment feature (alignment feature 401 shown in FIG. 4 and not pictured in FIG. 5), which may be referred to as a tongue, which a material handling robot may place into the quick-cure adhesive within the retention feature 507 of the first structure 501. The tongue may include a plurality of segments spaced apart from each other (e.g., alignment feature 401 with a comb shape shown in FIG. 4), a plurality of openings (e.g., a waffle or grid shape) or may be a solid tongue which contacts the quick-cure adhesive when the alignment feature (tongue) is inserted into the retention feature 507.

Two parts may be adhered together in various ways. Adhesion may be performed manually, semi-automatedly, or automatedly. In the exemplary case of an AM structure used in a structure-to-panel connection, adhesive, sealant, and/or vacuum ports may be 3-D printed into the AM structure to enable an automated constructor to inject adhesive at a preconfigured port. The automated constructor, such as a robot, may use an effector specifically designed to inject adhesive into an injection port. In some cases, only adhesive is injected. In other cases, sealant may be injected to circumscribe the areas to where the adhesive can flow. A vacuum may also be applied in some cases to facilitate the flow of the adhesive into an adhesive region located at an interface between a surface of the AM structure and a surface of the panel.

FIG. 6 illustrates a top view of an example of an AM female structure with a UV feature 600.

To eliminate the pausing and starting of a dispenser applying a first adhesive into the groove, the present disclosure provides a AM female structure with the UV feature 600 with a tongue and groove joint close to UV features 603a, 603b that allows the first adhesive to be injected in a continuous adhesive path within the groove of the structural section 601. FIG. 6 illustrates an example of an AM female structure with tongue and groove joints closest to the UV feature 603a, 603b having an inward curve towards a center space of the structure to form a continuous section. Thus, even though UV feature 603a, 603b will remain in its existing place relative to the AM female structure with the UV feature 200 shown in FIG. 2, the continuous adhesive path of the groove of the structural section 601 allows the robot dispenser to continuously fill an adhesive path of the structural section 601 without being interrupted (e.g., pausing and resuming dispensing) to go around the UV feature 603a, 603b as shown in FIGS. 2-3C. Thus, this design allows an interrupted dispending of structural adhesive which minimizes the chances of contaminating the structural adhesive into the UV section and reduces assembly time.

In some examples, the shape of the UV chambers may be designed to allow for a smooth dispensing of structural adhesives. For example, as shown in FIG. 6, the shape may be less rectangular and more curved.

Another advantage of the disclosure will be to minimize the potential for open spaces along the bond line of the structures which may exist due to compartmentalized housing of structural and retention adhesives being placed in a series configuration. The open spaces may encourage penetration of water and other liquids into the open internal spaces within the assembly and cause potential harm to the structures.

Yet another benefit of the present disclosure providing the AM female structure with a UV feature 600 is improving the strength of the joints by increasing the structural adhesive due to an increased surface area of structural adhesive as compared to the surface area of the structural adhesives in the AM female structure with the UV feature 200 shown in FIG. 2. In some examples where the UV feature is added as part of the structure, since the UV adhesive may not be as strong as the structural adhesive, the integrity of the structure may be weakened due to having less volume (or surface area) of the structural adhesive in the joint. However, as shown in FIG. 6 and in comparison to the AM female structure with the UV feature 200 shown in FIG. 2, when the structural section 601 is continuous around the entire structure, the structural section 601 has at least two extra segments that contribute to the bonding of the assembly since there is more surface area in contact with the structural adhesive. In addition, when the AM male structure with a tongue is inserted, the male segment with the tongue reinforces the structural strength when inserted into the AM female structure.

In some examples, an AM female structure with a UV feature may have UV chambers outside of the joint.

FIG. 7 illustrates a top view of an example of an AM female structure with a UV feature 700.

Similar to the continuous adhesive path of the groove of the structural section 601 shown in FIG. 6, the present disclosure provides a continuous structural section 701 that allows for the robotic applicator to continue filling the continuous structural section 701 in an adhesive path without being interrupted (e.g., pausing and resuming dispensing) to go around the UV feature 703a, 703b. As compared the AM female structure with the UV feature 200 shown in FIG. 2, FIG. 7 shows a AM female structure with the UV feature 700 with a UV feature 703a, 703b having a less in-depth UV feature depth that is minimized to achieve assembly tolerance. This allows space behind the UV feature 703a, 703b to be part of a continuous structural adhesive groove corresponding to the continuous structural section 701. When reducing the width of the UV feature 703a, 703b, the depth of the UV feature 703a, 703b should stay within some parameters such that the tongue may be inserted into that segment.

In some examples, the UV feature 703a, 703b may stay the same size and, instead, the continuous structural adhesive groove corresponding to the continuous structural section 701 may be broadened to form a continuous adhesive path. In some examples, the tongue part of the assembly may be designed to maximize penetration of actinic radiation, while maintaining a sufficiently thin but strong tongue to achieve the desired bonded property.

In another embodiment, the tongue portion of the enclosure may be absent in parts of the joints and, more specifically, in proximity of the UV features shown in the AM female structure with a UV feature 600 and the AM female structure with a UV feature 700 shown in FIGS. 6 and 7, respectively.

In another embodiment, the dispensing of adhesive may be continued without interruption, or by reduction of dispense volume in a standard joint design by simply “going around” the UV feature such that adhesive is dispensed into an inner hollow space of the node without a dedicated groove for this adhesive.

Although FIGS. 2-7 discuss the embodiments using structural chambers and adhesives, UV adhesives and chambers and tongue and groove type joints, it should be noted that the disclosure should not be limited to only a certain type of structural chambers and adhesives, UV chambers and adhesives, the number of UV chambers, or tongue and/or groove type joints. Instead, the disclosure can apply to any two of segmented chambers that use different adhesives and any joints.

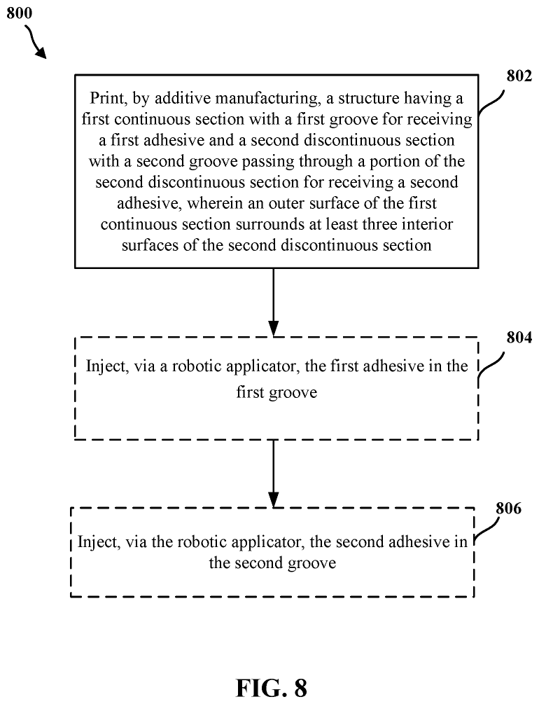

FIG. 8 illustrates a process in accordance with an aspect of the present disclosure.

FIG. 8 is a flowchart 800 illustrating an exemplary process for printing an AM structure in accordance with the systems and methods described herein. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

At block 802, the method 800 may include printing, by additive manufacturing, a structure having a first continuous section with a first groove for receiving a first adhesive and a second discontinuous section with a second groove passing through a portion of the second discontinuous section for receiving a second adhesive. For example, block 802 may include operation of a 3-D printer system (e.g., PBF system 100) or another additively manufacturing system to print an AM structure. An outer surface of the first continuous section may surround at least three interior surfaces of the second discontinuous section. As an example, referring back to FIG. 6, the outer surface of the structural section 601 surrounds at least three interior surfaces of the second discontinuous section (UV features 603a, 603b). As another example, referring back to FIG. 7, the outer surface of the continuous structural section 701 surrounds at least three interior surfaces of the second UV feature 703a, 703b.

In some examples, the first continuous section may include a portion of an outer surface with a convex shape. As an example, referring back to FIG. 6, the structural section 601 may include a portion of an outer surface with a convex shape.

In some examples, the second discontinuous section may include an outer surface with a window. As an example, referring back to FIG. 6, the second discontinuous section (UV features 603a, 603b) includes a portion of an outer surface with a convex shape.

Optionally, at block 804, the method 800 may include injecting, via a robotic applicator, the first adhesive in the first groove. As an example, referring back to FIG. 6, the method may include injecting, via a robotic applicator, a structure adhesive in the first groove of the structural section 601. As another example, referring back to FIG. 7, the method may include injecting, via a robotic applicator, a structural adhesive in the first groove of the continuous structural section 701.

Optionally, at block 806, the method 800 may include injecting, via the robotic applicator, the second adhesive in the second groove. As an example, referring back to FIG. 6, the method may include injecting, via a robotic applicator, a UV adhesive in the second groove (e.g., chambers) of the UV features 603a, 603b. As another example, referring back to FIG. 7, the method may include injecting, via a robotic applicator, a UV adhesive in the second groove (e.g., chambers) of the UV features 703a, 703b.

In some examples, the first continuous section may correspond to a structural section and the second discontinuous section corresponds to a UV section. As an example, referring back to FIG. 6, the structural section 601 corresponds to a structural section and the second discontinuous section (UV features 603a, 603b) corresponds to a UV section. As another example, referring back to FIG. 7, the continuous structural adhesive 701 corresponds to a structural section and the UV feature 703a, 703b corresponds to a UV section. In some examples, the first adhesive may correspond to a structural adhesive and the second adhesive may correspond to a UV adhesive. In some examples, the first adhesive may be injected into the first groove before the second adhesive may be injected into the second groove.

In some examples, the first continuous section may include a first adhesive port for injecting the first adhesive into the first groove and the second discontinuous section may include a second adhesive port for injecting the second adhesive into the second groove.

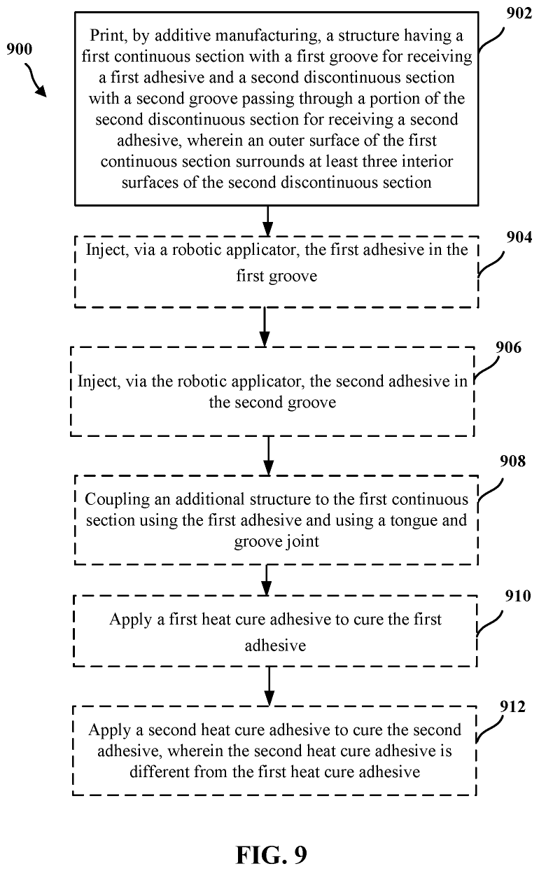

FIG. 9 is a flowchart 900 illustrating an exemplary process for printing an AM structure in accordance with the systems and methods described herein. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

At block 902, the method 900 may include printing, by additive manufacturing, a structure having a first continuous section with a first groove for receiving a first adhesive and a second discontinuous section with a second groove passing through a portion of the second discontinuous section for receiving a second adhesive. For example, block 902 may include operation of a 3-D printer system (e.g., PBF system 100) or another additively manufacturing system to print an AM structure. An outer surface of the first continuous section may surround at least three interior surfaces of the second discontinuous section.

Optionally, at block 904, the method 900 may include injecting, via a robotic applicator, the first adhesive in the first groove.

In some examples, a structural adhesive robot, connected with a structural adhesive applicator may move its robotic arm to a position such that the structural adhesive applicator is above the groove, and is sufficiently close so that a controlled amount of the structural adhesive can be deposited within a defined area in the groove while avoiding deposition of the structural adhesive elsewhere. At such an above position, an adhesive application tip of the structural adhesive applicator may be approximately directly above groove, and may be pointed downward into the upwardly facing groove.

When suitably positioned, structural adhesive robot may cause structural adhesive applicator to deposit the controlled amount of structural adhesive into the groove. The controlled amount of structural adhesive may at least partially fill groove. In some embodiments, the controlled amount of structural adhesive may entirely or nearly entirely fill groove.

The amount of structural adhesive, however, may be controlled such that the structural adhesive does not overflow outside groove and onto the first surface of a second structure that bounds groove. For example, the amount of structural adhesive deposited in groove may be controlled such that the structural adhesive does not leak onto any surfaces of the second structure when a protrusion another structure is inserted into groove when the second structure is joined with the other structure.

Optionally, at block 906, the method 900 may include injecting, via the robotic applicator, the second adhesive in the second groove.

In some examples, a UV robot may be located relatively proximate to keystone robot and assembly robot. The distal end of the robotic arm of the UV robot may be positioned toward the point at which a first structure and a second structure are positioned at the joining proximity (e.g., toward the tongue-and-groove joint). In such a position, the distal end of the robotic arm of the UV robot may be between the keystone robot and assembly robot.

The distal end of the robotic arm of the UV robot may be positioned such that tool is proximate to the point at which the first structure and second structure are at the joining proximity. At a suitable distance, the UV robot may apply UV adhesive on and/or near the tongue and groove joint formed by positioning the first structure and second structure at the joining proximity.

Optionally, at block 908, the method 900 may include coupling an additional structure to the first continuous section using the first adhesive and using a tongue and groove joint. As an example, referring back to FIG. 5, the second structure 503 may be coupled to the first structure 501 using a first adhesive and using a tongue and groove joint.

Optionally, at block 910, the method 900 may include applying a first heat cure adhesive to cure the first adhesive. In contrast to various other assembly systems that may include a positioner and/or fixture table, the user of a curable adhesive may provide a partial adhesive bond that provides a way to retain the first and second structures during the joining process without the use of fixtures. The adhesive bond may provide one way to replace various fixtures that would otherwise be employed fore engagement and retention of structures in an assembly system that, for example, uses a positioner and/or fixture table. Another potential benefit of fixtureless assembly, particularly using a curable adhesive, is improved access to various structures of a structural assembly in comparison with the use of fixtures and/or other part-retention tools, which inherently occlude access to sections of the structures to which they are attached.

Optionally, at block 912, the method 900 may include applying a second heat cure adhesive to cure the second adhesive. The second heat cure adhesive may be different from the first heat cure adhesive. In some examples, the first adhesive may be as structural adhesive and the second adhesive may be a quick-cure UV adhesive. In some examples, a “UV robot” may include a tool at a distal end of a robotic arm that is configured to apply a quick-cure UV adhesive and to cure the adhesive, e.g., when a first structure is positioned within the joining proximity with respect to a second structure. That is, the UV robot may cure an adhesive after the adhesive is applied to the first structure and/or second structure when the structures are within the joining proximity obtained through direction of at least one of the robotic arms of a keystone robot and/or assembly robot.

In some examples, referring back to FIG. 5, a UV robot may position tool at a distance from the UV adhesives that is suitable for curing the UV adhesive through the retention features 507, which may be a same position or a different position as that at which the UV adhesive was earlier applied. With tool at this distance, UV robot may cause UV light applicator of the tool to cure the UV adhesive. For example, the UV robot may cause UV light applicator to emit UV light for a time sufficient to cure the UV adhesive. However, the UV robot may not cure the structural adhesive, e.g., because the structural adhesive may not be curable through exposure to UV light.

In some embodiments in which UV adhesive is applied at more than one location on the first structure and second structure, the UV robot may move the tool to different positions, each of which may be suitable for curing the UV adhesive applied at different locations across the first and second structures. The UV robot may hold the tool at each of the different positions for a time period that is sufficient to cure the UV adhesive while the UV light applicator emits UV light for curing.

Moreover, at least partially replacing fixtures and/or other part-retention tools with curable adhesives may provide a more reliable connection at one or more locations on a structural assembly in need of support-particularly where locations in need of support are rendered nearly or entirely inaccessible by the fixtures and/or other part retention tools. In addition, at least partially replacing fixtures and/or other part-retention tools with curable adhesives may provide the ability to add more structures to a structural assembly before application of a (permanent) structural adhesive-particularly where fixtures and/or other part retention tools would hinder access for joining additional structures.

### Advantages of the Present Disclosure

In an aspect of the disclosure, the disclosure provides a benefit for a robotic assembly process. For instance, improvements include the reduction of dispensing time of structural adhesives via the redesign of structure joints. Specifically, the removal of UV chambers in the way of adhesive dispensing allow for the uninterrupted dispensing of structural adhesives. There are several other advantages and benefits such as reduced contamination by removing “stringing” and increasing the amount (e.g., surface area) of structural adhesive which holds a frame together since, in some cases, there may be an extra segment contributing to bonding of assembly. In addition, the redesign of joint structures minimizes requirements for cure depth of the adhesive since the tongue and groove bonding surfaces will be closer to the window. This allows the shape of the UV feature tongue and groove to be designed to maximize bonding force. Furthermore, some aspects of the present disclosure allows for use of UV curable adhesives (e.g., UV/structural adhesives) which may be less permeable to actinic radiation. This may greatly improve chances of successful formulation of such adhesives.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other techniques for printing structures and interconnects. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus, comprising:
an additively manufactured structure having a first continuous section with a first groove for receiving a first adhesive and a second discontinuous section with a second groove passing through a portion of the second discontinuous section for receiving a second adhesive, wherein an internal surface of the first continuous section surrounds at least three internal surfaces of the second discontinuous section.

2. The apparatus of claim 1, wherein the first continuous section comprises a portion of an outer surface having a convex shape.

3. The apparatus of claim 1, wherein the second discontinuous section has an outer surface with a window.

4. The apparatus of claim 1, wherein the first adhesive is injected, via a robotic applicator, in the first groove and the second adhesive is injected, via the robotic applicator, in the second groove, wherein the second adhesive is different from the first adhesive.

5. The apparatus of claim 1, wherein the first continuous section corresponds to a structural section and the second discontinuous section corresponds to an ultra-violet (UV) section.

6. The apparatus of claim 5, wherein the first adhesive corresponds to a structural adhesive and the second adhesive corresponds to a ultra-violet (UV) adhesive.

7. The apparatus of claim 6, wherein the first adhesive is injected into the first groove before the second adhesive is injected into the second groove.

8. The apparatus of claim 1, wherein the first continuous section comprises a first adhesive port for injecting the first adhesive into the first groove and the second discontinuous section comprises a second adhesive port for injecting the second adhesive into the second groove.

9. The apparatus of claim 1, wherein the first continuous section is configured to be coupled to an additional additively manufactured structure using a tongue and groove joint.

10. The apparatus of claim 1, wherein the first adhesive is cured using a first heat cure adhesive and the second adhesive is cured using a second heat cure adhesive different from the first heat cure adhesive.

11. A method comprising:
printing, by additive manufacturing, a structure having a first continuous section with a first groove for receiving a first adhesive and a second discontinuous section with a second groove passing through a portion of the second discontinuous section for receiving a second adhesive, wherein an outer surface of the first continuous section surrounds at least three interior surfaces of the second discontinuous section.

12. The method of claim 11, wherein the first continuous section comprises a portion of an outer surface with a convex shape.

13. The method of claim 11, wherein the second discontinuous section comprises an outer surface with a window.

14. The method of claim 11, further comprising:
injecting, via a robotic applicator, the first adhesive in the first groove; and
injecting, via the robotic applicator, the second adhesive in the second groove.

15. The method of claim 11, wherein the first continuous section corresponds to a structural section and the second discontinuous section corresponds to a ultra-violet (UV) section.

16. The method of claim 15, wherein the first adhesive corresponds to a structural adhesive and the second adhesive corresponds to a UV adhesive.

17. The method of claim 16, wherein the first adhesive is injected into the first groove before the second adhesive is injected into the second groove.

18. The method of claim 11, wherein the first continuous section comprises a first adhesive port for injecting the first adhesive into the first groove and the second discontinuous section comprises a second adhesive port for injecting the second adhesive into the second groove.

19. The method of claim 11, further comprising:
coupling an additional structure to the first continuous section using the first adhesive and using a tongue and groove joint.

20. The method of claim 12, further comprising:
applying a first heat cure adhesive to cure the first adhesive; and
applying a second heat cure adhesive to cure the second adhesive, wherein the second heat cure adhesive is different from the first heat cure adhesive.
